(19) United States
(12) Patent Application Publication
(10) Pub. No.: US 2014/0331019 A1
(43) Pub. Date: Nov. 6, 2014

(54) INSTRUCTION SET SPECIFIC EXECUTION ISOLATION

(71) Applicant: Microsoft Corporation, Redmond, WA (US)

(72) Inventors: Matthew J. Parker, Bellevue, WA (US); Marc Tremblay, Clyde Hill, WA (US); Landy Wang, Honolulu, HI (US); Matthew R. Miller, Seattle, WA (US); Kenneth D. Johnson, Bellevue, WA (US)

(73) Assignee: Microsoft Corporation, Redmond, WA (US)

(21) Appl. No.: 13/970,598

(22) Filed: Aug. 20, 2013

Related U.S. Application Data
(60) Provisional application No. 61/820,130, filed on May 6, 2013.

(51) Int. Cl. G06F 12/14; G06F 12/10

(52) U.S. Cl. CPC G06F 12/1458; G06F 12/1009
USPC 711/163

(57) ABSTRACT

A system on a chip (SoC) or other integrated system can include a first processor and at least one additional processor sharing a page table. The shared page table can include permission bits including a first permission indicator supporting the processor and a second permission indicator supporting at least one of the at least one additional processor. In one implementation, that page table can include at least one additional bit to accommodate encodings that support the at least one additional processor. When one of the processors accesses memory, a method is performed in which a shared page table is accessed and a value of the permission indicator(s) is read from the page table to determine permissions for performing certain actions including executing a page; read/write of the page; or kernel mode with respect to the page.

### CROSS-REFERENCE TO RELATED APPLICATION

This application claims the benefit of U.S. Provisional Application Ser. No. 61/820,130, filed May 6, 2013.

### BACKGROUND

A system on a chip (SoC) generally refers to the integration of processor(s), peripheral component(s), and physical memory as part of a same silicon chip or as a stack of chips bonded or otherwise packaged together. Other computing systems may include integrated components that are designed or connected to function together for a cohesive product. For integrated systems, including SoCs, more than one processor—and even more than one type of processor—may be integrated. Each processor has an associated instruction set providing an interface between the software and the silicon. The processors may use a common instruction set architecture or they may involve different instruction set architectures—even with different underlying microarchitecture implementations.

A common issue in computing systems, including SoCs, is the need for more memory than may physically exist in a system. Virtual memory is one approach for overcoming the limitation of physical memory. Virtual memory provides a greater range of software addresses than present for the physical memory and enhances sharing the physical memory between multiple processes (and even processors).

In addition to using virtual memory, certain processor configurations allocate separate memory locations for instructions and data. The separation of instructions and data is one approach to improve efficiency, and this separation can be leveraged to improve security of a processor system by allowing a processor to execute code from a memory location designated as being instructions while not allowing the processor to execute code from a memory location designated as being data. In this manner it is possible to scan instructions for malicious code and inhibit malicious code from being executed from regions in memory indicated as storing only data.

Efficient, yet secure, use of memory for integrated systems having multiple processors and different instruction sets, including SoC devices, continues to be an avenue for exploration.

### BRIEF SUMMARY

Techniques and systems are discussed for enabling multiple types of processors to share a same page or region of physical memory while maintaining instruction set execution isolation.

According to one implementation, a system can include a first processor; and at least one additional processor sharing a page table with the first processor. The shared page table includes a first permission indicator for the first processor and a second permission indicator for the at least one additional processor, which enables both the first processor and the at least one additional processor to access a same memory location while maintaining execution isolation of the different instruction sets used by the first processor and the at least one additional processor.

A method of accessing memory is described that includes accessing a page table shared by a first processor and at least one additional processor sharing a physical memory with the first processor, wherein the page table comprises a first permission indicator for the first processor and a second permission indicator for the at least one additional processor; and performing an action with respect to a page of the physical memory based on a value of the first permission indicator or the second permission indicator, the value being indicative of a permission related to a designated action.

Another method of accessing memory is described that includes receiving a virtual memory address; translating the virtual memory address to a physical memory address using a page table shared by a first processor and at least one additional processor having a different instruction set than that of the first processor; and utilizing permission bits of the page table to control physical memory access, the permission bits comprising a first permission bit supporting the first processor and at least one permission bit to accommodate encodings that support the at least one additional processor.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A-1C illustrate a system diagram with representations of some implementations for instruction set isolation of a shared memory and page table.

FIG. 2 illustrates virtual address spaces of two processes that may be carried out by different processors sharing a page table and physical memory according to an embodiment.

FIG. 3 illustrates a method of accessing memory according to an embodiment.

### DETAILED DESCRIPTION

To facilitate the sharing of not just the same physical memory, but also to facilitate the sharing of a page table, permission indicators for at least one additional processor having a different instruction set architecture or other characteristic can be included in the page table for a processor of an integrated system. The integrated system may include a SoC where multiple processors and/or devices are fabricated on a same piece of silicon or fabricated separately and stacked in a package or on a package substrate.

In certain implementations, multiple processors are able to share system memory while maintaining instruction set isolation by increasing the number of permission bits used to control a processor's permissions with respect to a page of memory by at least one bit to accommodate encodings that support additional processor types.

More than one processor—and even more than one type of processor—may be integrated on a chip or package substrate. For example, a central processing unit (CPU), graphics processing unit (GPU), image signal processor (ISP) and other processors may form part of the system. Furthermore, each of these processors may be provided in plurality. In addition, direct memory access (DMA) controllers may be incorporated to enable certain components of the system to independently access the associated memory.

“Memory” refers to logical memory, the operating system managed information storage through the use of page tables.

“Memory storage” refers to physical memory, which may be on-chip (e.g., cache memory) or off-chip (e.g., dynamic random access memory (DRAM), hard disks, optical drives, flash drives, and the like).

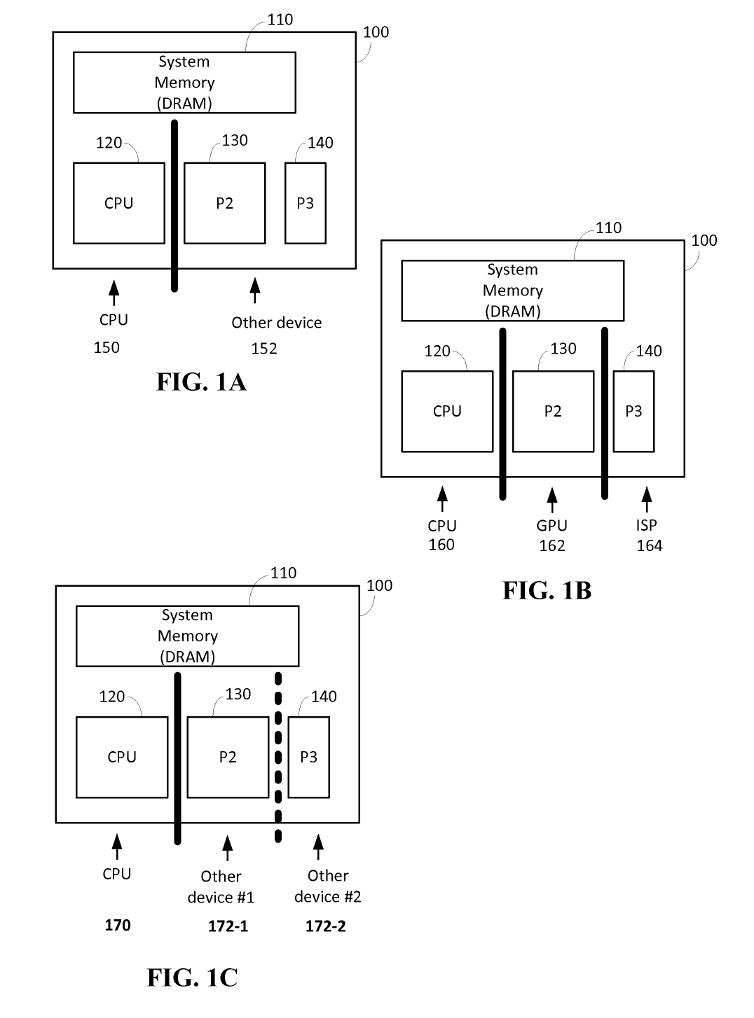

FIGS. 1A-1C illustrate an integrated system diagram with representations of some implementations for instruction set isolation of a shared memory and page table. Referring to FIGS. 1A-1C, an integrated system 100 can include a memory storage 110 (such as DRAM); a first processor 120 (such as a CPU); and at least one additional processor that can share the memory storage 110, for example a second processor 130 (such as a GPU) and a third processor 140 (such as an ISP). In some implementations, the two or more processors can include processors having different characteristics. For example, two or more CPUs may be integrated where one (or more) of the CPUs are characterized by being operated for secure processes and one (or more) of the CPUs are characterized by being operated for the kernel. These two or more CPUs may share a same page table.

The physical memory available to the system (including memory storage 110) can include volatile and/or non-volatile memory. Some physical memory may be on-chip, for example, a software invisible cache. In some cases, the operating system, drivers, and/or programs may also be stored (or at some point loaded) onto the physical memory available to the system.

Access to memory by processes executed by the processor(s) (120, 130, 140) may be restricted either by access or by use. For example, some memory, such as that containing executable code, is typically restricted to being read only memory. It is understood that a process should not be allowed to write data over an operating system's executable code. In contrast, pages containing data could be available for writing to; however, attempts to execute from the pages containing data (as if the data are instructions) should not be allowed for security purposes. To provide these restrictions, most processors have at least two modes of execution: kernel and user (i.e., unrestricted and restricted modes).

A page can have a variety of permissions associated with it. In some cases, the page permissions are allocated bits in a register, page table, or other data structure that can be accessed and read by an operating system before performing an action with respect to a memory location (or address). Permissions can include, but are not limited to read/write, execute (or never execute or only execute), and supervisor (kernel access). An execute-only page refers to a page from which code may be executed by the processor, but a user-level program is restricted from reading the page as data or writing to the page. In certain embodiments, these permissions are indicated by a bit (or bits), when set or cleared, that the permission is granted or denied.

Certain embodiments utilize virtual memory to increase the amount of memory a program may address as well as to dissociate the memory from the size of the physical memory (and increase memory utilization). For example, virtual memory enables multiple programs to access the same physical memory (such as memory storage 110) while using different virtual addresses, making the memory space appear larger than the hardware would indicate.

The sharing of the underlying memory storage 110 by the first processor 120 and at least one additional processor (e.g., second processor 130 and/or third processor 140) can be managed by software such as an operating system. An operating system maps a virtual address provided by a process to the physical address where the data or instruction is stored. An instruction is a type of data understandable by a processor to carry out a process. The differentiation of data and instruction used here is merely to emphasize the purpose of the data stored in memory. In some cases, how data and instructions are stored may differ, but the data for these two purposes are, at a physical level, reflected as bits in memory.

The management of address mapping and permissions (through retaining page table information) can be carried out at the granularity of a page. The size of a page may be controlled by software or associated applications with some possible constraints by the physical memory available to the system. The size of a page may be a size that the operating system manages for mapping virtual memory allocations to physical memory and managing permissions for data stored on that page.

In addition to sharing the same physical memory (while not necessarily the same pages), in some scenarios it may be desirable to share data between multiple processors, including situations where a page is writable from one processor (such as a CPU 120), but only readable from a second processor (such as a GPU 130).

Currently, a CPU has certain permission controls associated with a page of memory. A page fault can occur when a process references a non-mapped page or encounters a permission error. When a page fault occurs, the operating system blocks the running process and may perform other specified actions. Embodiments augment the available permissions for a CPU (and in some cases the fault handling) to the other processors sharing the memory with the CPU.

Therefore, providing permission control for other processors sharing the memory with the CPU can inhibit exploitation of the shared memory (via malicious software or code) when used for the other processors.

The system 100 can include a memory management unit for the processor(s). The memory management unit may access the memory storage 110 to read from a directory page, read from a page table, or read a byte (or bits) from a memory location.

A page table refers to the data structure construct in which the operating system may store its mappings of virtual addresses to physical addresses. In general, each mapping may be referred to as a page table entry.

The conversion from virtual address to physical address may be referred to as a translation. Recently used virtual address to physical address translations may be cached in a translation lookaside buffer (TLB), which can speed up translations. The TLB may be included as on-chip physical memory.

In addition to mapping a virtual memory address to a physical memory address, a page table entry includes access control information. A processor (e.g., 120, 130, 140) can use the access control information to check that a process being executed by the processor is not accessing memory inappropriately.

To enable a same page table to be used for two processes (or processors), certain embodiments of the invention provide an additional permission indicator as part of the page table. The additional permission indicator may be an additional bit or bits in a page table (or an assigned use for an existing bit of a page table). Certain implementations provide analogous processor permission bits to the CPU permission bits available as part of a page table.

According to certain implementations, one or more bits of a page table are allocated to the access control information and can indicate permissions and other information including, but not limited to, whether the address is valid; whether to report a page fault (which can be a fault on execute, fault on write, or fault on read as examples); kernel mode; user mode; page frame number or other location; whether the page has been accessed; and whether the page is allowed to be executed, read, or written to. To discern the different permissions while using a shared page table, certain bits of the page table can be used to encode the permissions for the processors sharing the page table.

For every page of memory, there may be a 64 bit field (or other size page table). The larger the page table, the higher number of page accesses may occur in order to “walk” the page table to find the encoding. Accordingly, instead of providing larger page tables to include additional permission bits, some of the bits of a page table may be used in combination (e.g., two bits to encode four states or three bits to encode eight states). In another implementation, cascading page tables (or a tree structure) may be used in order to provide additional permission bits.

As an alternative to bits in the page table, another data structure may be used and searched by an operating system before fetching data from a memory location. By including the bits as part of the page table (or other data structure), the permissions can be determined during a same process as used to convert a virtual address to a physical address.

In another scenario, the shared page table may be encoded in a manner that each processor accessing the shared page table can decode the bits differently (or with particular permissions). For example, the operating system may decode the page table based on the processor type. Certain bits of a data structure, which may be the page table, can be designated to indicate the processor and control how the page is viewed. That is, the page table entry bits can have different meaning upon the processor accessing the page table. For certain scenarios, each processor may view the same bits as different according to a particular encoding or instruction set expected by that processor.

A page table entry may be decoded based on processor type. The processor type indicator may be part of the page table entry, where one or more bits indicate the processor type to which the permissions are associated with. In some cases, the processor type indicator may be available from reading a parallel data structure.

In one embodiment, the page table provides a distinction between the CPU 120 and “other” processors (e.g., 130, 140), as illustrated in FIG. 1A. For example, for a given permission, a permission indicator may be available for the CPU (as a first permission indicator 150) and another permission indicator may be available for the other processors (as a second permission indicator 152). When a process accesses a page through translating a virtual address to a physical address using a page table, the first and second permission indicators enable different permissions for a CPU 120 executing a process and the additional processor(s) as a whole (by the general second permission indicator 152) when any other processor executing a process fetching a same page.

In another embodiment, the page table provides a distinction between each processor sharing the page table or between at least two processors sharing the page table, as illustrated by FIG. 1B. For example, a permission indicator may be available for a shared page that can differentiate permissions for the processors 120, 130, and 140, for example by CPU indicator 160, GPU indicator 162, and ISP indicator 164.

In another embodiment, a shared page table may include the differentiation as described with respect to FIG. 1A in which a CPU permission indicator 170 and an “other” processor permission indicator (e.g., 172) distinction is available. However, to provide a differentiation (and ability to separately control permissions for the other processors), a table or other data structure associated with the page table can be used to distinguish between the other processors, as illustrated by FIG. 1C. This table or other data structure may be a parallel structure to the page table. Thus, a permission indicator in the page table with the CPU permission indicator 170 can be associated with a particular processor using the table or other data structure. For example, the permission indicator can be associated with one processor as 172-1 or another processor as 172-2 even though it is a single indicator in the page table.

In another implementation, a single permission bit may be used to indicate permissions for the multiple processors in the page table, and a processor identifier table or other data structure associated with the page table can be used to distinguish between the processors.

Permissions bits that may be used to control permissions for multiple processors sharing a same page table include, but are not limited to a never-execute (or instruction fetch) bit, a read/write bit, and a supervisor mode bit. In some cases, existing bits of a page table (that may be available as being reserved for future use) can be used to form the two or more bits assigned to represent the permission(s) for the processor (or process).

A never execute (or “no execute”) bit or an inverse such as an always execute bit may be used by the operating system to inhibit malicious code from being executed. For example, some malicious code may attempt to run from a region of memory designated as data (as opposed to instructions/code). The portions of the code downloaded to an executable region may appear benign when scanned but include a jump instruction to the region of memory designated as data. A never execute bit can be used by the operating system to inhibit any code that may be stored in the data page or data buffer from being executed. Instead, when the address is being retrieved from the page table, the page table entry for the address in the page table can indicate that the page is not to be executed.

Thus, if malicious instructions or code are stored in the data region a flag (or set bit representing the never execute bit) can help prevent the code from being executed when executable code indicating a jump to the region is executed. When the system determines that executable code is being attempted to be executed from a region having the never execute bit set (for example to 1), the system can indicate a fault. The operating system may perform fault processes at that point.

For convenience in the following example, the permission bit(s) are referred to as an X bit (or bits). In one embodiment one X bit is for the CPU and the CPU processor checks the X bit of a page table to see if it is set (0 or 1) to indicate the permission. Another X bit may be provided for any other processor sharing the page table. This other additional processor X bit can be checked by additional processor to see if it is set (0 or 1) to indicate the permission. The available states for the CPU X bit and the additional processor X bit include 0 and 1. A separate table (or other data structure) may be used to indicate the particular processor (if more than one additional processor is part of the integrated system) that has permissions associated with the additional processor X bit of the page.

In another embodiment, the X bit can be two bits having states of 00, 01, 10, and 11 available. The meaning assigned to the states can vary so long as the meaning is consistent. For example, 00 may be reserved (e.g., indicate a fault or another later defined permission), 01 may indicate that the CPU has permission, 10 may indicate that one of the additional processors has permission, and 11 may indicate that another of the additional processors has permission for a page.

By sharing a page table as described herein, code may run more efficiently because a page with pointers can be accessed by multiple processors and mapped to a same address. One area where this is useful is where data may be shared between multiple processors.

The processor and even some of the other processors of the integrated system may process data according to instructions of one or more application programs, drivers, and/or operating system. According to certain embodiments, a single operating system can perform memory management (and specifically page table management) for both a CPU and a GPU and even other processors that usually are controlled/managed by their own drivers.

As a processor executes a program, the processor reads an instruction from memory and decodes the instruction. The processor may perform steps of fetching or storing contents of a memory location when decoding the instruction. The memory location is indicated by an address, which falls within a page of memory. Once the instruction is decoded, the processor executes the instruction and moves to the next instruction. When the processor performs the steps of fetching or storing contents of a memory location and the memory location is a virtual address, the virtual address is converted by the processor into a physical address using information held in a set of tables maintained by the operating system.

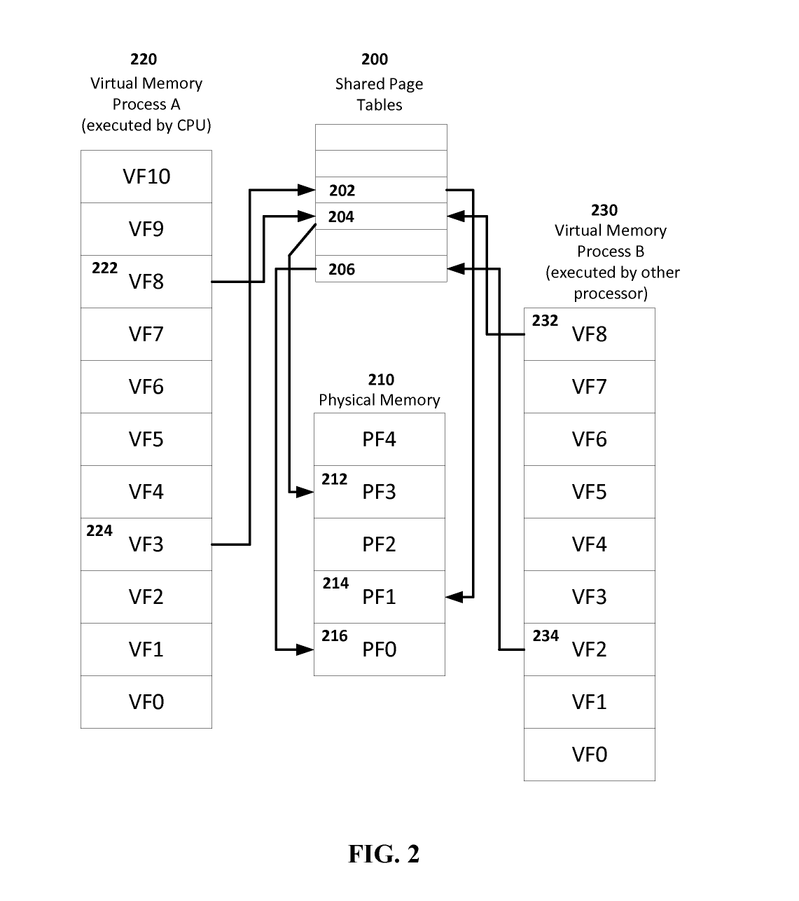

FIG. 2 illustrates virtual address spaces of two processes that may be carried out by different processors sharing a page table and physical memory according to an embodiment.

A page table 200 can be shared by multiple processors that also share a same physical memory 210. In this environment, virtual address spaces may exist for two processes: one virtual address space 220 for process A executed by one processor (such as a CPU) and another virtual address space 230 for process B executed by another processor.

A process's virtual address space may contain its code (executable code/instructions), data, and stack (e.g., available variable memory space). The address space may cover multiple pages. Code pages may be stored in a file on disk or memory. The data and stack pages are also stored in a file that may be created or utilized while a program is executing. The operating system manages virtual memory and can determine the portions of a process's virtual address space are mapped in memory at a given time. Virtual memory is handled partly by hardware (translation mechanism) and partly by the operating system (sets up page table, handles page faults, and the like).

According to various embodiments, the shared page table 200 can map both processes (process A and process B). Each entry in the page table can include a number of flags including valid entry indicator and access control information (permission indicators) in addition to the physical page frame number.

As with physical memory (described as being divided into pages or “frames”), the virtual memory space is divided into memory units called pages that usually mirror the size of the physical memory page frame.

A page contains a predetermined number of basic addressable units. For example, the basic addressable unit may be, for example 8-bits, 16-bits, or 32-bits. The size of the page may vary according to system; however, common page sizes are 4 Kbytes and 8 Kbytes.

Each page in memory is given a unique number that enables the page to be addressed. In some cases, each byte in a page (virtual or physical) may be addressed. The unique number given to each page may be referred to as a page frame number. Both physical pages and virtual pages are assigned a page frame number (e.g., VF and PF numbers in FIG. 2).

A virtual address may include an offset part and a virtual page frame number part. When a processor encounters a virtual address, the processor may use a page table (and/or a TLB when previously translated using the page table) in order to determine the physical address and access its content. The offset part and virtual page frame number part may be extracted from a virtual address and used to assist in determining a physical address from a page table.

In the illustration shown in FIG. 2, page frame number 8 (VF8) 222 in process A's virtual address space 220 is mapped into memory 210 in physical frame number 3 (PF3) 212 by using the shared page table 200. In particular, the operating system accesses page table entry 204, which provides the translation of VF8 222 to PF3 212. In some cases, the page table entry may be found using the virtual page frame number as an offset.

Process B executed by the other processor(s) shares the page table 200 and may have virtual addresses that are translated using a same page table entry as the process A. For example, page frame number 8 (VF8) 232 in process B's virtual address space 230 is mapped into memory 210 in PF3 212.

Permissions for these two processors can be different and can be controlled by the permission indicators in the page table entry.

The operating system expects there to be a bit in the page table entry that limits execution on the other processors that is distinct from the bit (or bits) that limits execution on the CPU. The hardware understands the bit availability, for example, in the translation lookaside buffer or other component of a hardware memory management unit.

The operating system (or device driver of one of the other processors) accessing the page table can access the page table entry and a parallel data structure that indicates processor type to which the permissions correspond. The parallel data structure indicating processor type to which the permissions correspond can include an indication of the processor type having the permission indicated in the page table entry while having a default permission for the remaining processors.

Permission bits for a page are provided that control permissions for at least two processors. In order to control the permissions for at least two processors, the number of permission bits can be increased by at least one from that or those available for a CPU in order to accommodate encodings that support additional processor types.

Other mappings illustrated in FIG. 2 include page frame number 3 (VF3) 224 in process A's virtual address space 220 mapped into memory 210 in physical frame number 1 (PF1) 214 using page table entry 202; and page frame number 2 (VF2) 234 in process B's virtual address space 230 mapped into memory 210 in physical frame number 0 (PF0) 216 using page table entry 206.

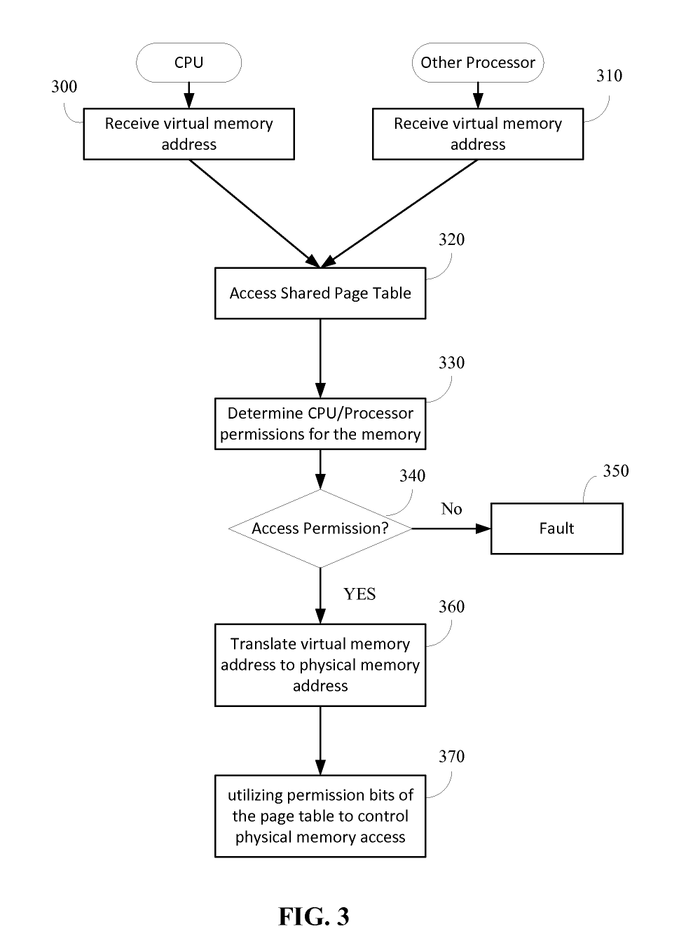

FIG. 3 illustrates a method of accessing memory according to an embodiment. A process being executed by a CPU may include receiving a virtual memory address (300). Similarly, a process being executed by a processor having a different instruction set architecture or characteristic from the CPU may include receiving a virtual memory address (310). In both processes, a shared page table is accessed (320). The shared page table can include permission indicators for both the CPU and other processor. The permission indicators in the page table can be read to determine the permissions for the CPU or other processor accessing the shared page table (330). A value of the permission bits can be read to determine the particular virtual memory address access permission for the CPU or other processor accessing the shared page table (340). If the permission bit(s) indicate that no access is permitted, then a fault condition can result (350). If the permission bit(s) indicate that access is permitted, then the virtual memory address can be translated to physical memory address using the shared page table (360). The permission bits of the page table can be used to control physical memory access and perform a designated action (370).

In concept, a physical address corresponding to a particular virtual address can be obtained by fetching the page table entry for the virtual page of that virtual address from physical memory and merging the byte number of the addressable unit of data with the page frame number contained in the page table entry. In many cases, the central processing unit maintains a translation buffer (the TLB) that is a special purpose cache of recently used page table entries. When using the TLB, the TLB may already contains the page table entries for the virtual addresses being used by a program and the processor need not go to physical memory to obtain them.

Example Case—Controlling Execution of an Instruction

In a computer system in which processors exist with more than one instruction set referencing shared system memory, it is possible for memory allocations that are treated as data on one processor to be consumed as executable code on another processor. For example, a page designated as GPU data may have data that is consumable by a host processor (e.g., a CPU) as executable code. If a CPU is executing instructions from a region designated as executable code and the executable code includes a jump instruction to a memory location indicated as GPU data, but this data includes the CPU executable code, a data security vulnerability may occur (or at a minimum, correctness and reliability issues).

Page tables are often maintained that contain an entry corresponding to each allocated page (representing a block of contiguous physical memory) that specifies if the memory block is executable. This is commonly implemented as a No-Execute bit (also called the NX bit) within each entry of the page table and host processors within the system will trigger fault handlers in the event that a memory location marked as no execute is being consumed as instructions on the host processor.

Although the No-Execute bit addresses the vulnerability of the host processors attempting execution of data buffers, the No-Execute bit does not address the vulnerability in other processors such as the GPU. According to certain implementations, instead of just providing execution control for the host processors, a control is provided to disable execution from memory allocations deemed to be data buffers for the processors which share memory objects with the host processor while allowing execution from memory allocations deemed as executable only for the intended processor type.

In one scenario, an existing page table entry “no execute” (or NX) bit is augmented with a processor type (PT) modifier. This PT modifier may be an additional bit or bits in the page table or a supplemental table utilized to determine the processor type to which the execution is allowed or disabled. A targeted system processor can trigger fault handlers in the event of attempted execution from a memory allocation which is either specified as no-execute within the page table entry or has an incorrect processor type modifier.

The bit or bits of the page table entry enable the disallowing of execution from memory allocations deemed as data when accessed from a system processor as well as the disallowing of execution from memory allocations deemed as executable for a processor type other than the executing processor.

By adding a sufficient number of Page Table Entry bits to encode a processor type field the system software can set the appropriate processor type encoding for allocations which are intended to contain executable code. Each processor may enforce triggering fault handlers in the event that execution is corresponding to memory allocations which are deemed either not executable or have an incorrect processor type encoding which is contained within a privileged register that is maintained by the operating system.

It should be understood that the block diagrams illustrating components of the integrated system are simplified and may include additional components and connections. For example, in addition to the main processor(s) and other on-chip (or otherwise interconnected) processors that have access to and may write or read data on the memory (as shown and described with respect to FIGS. 1A-1C), the integrated system may include network connectivity devices (e.g., a network interface), voltage regulators and/or sensors (e.g., magnetometer, an ambient light sensor, a proximity sensor, an accelerometer, a gyroscope, a Global Positioning System sensor, temperature sensor, shock sensor). Components of the integrated system may communicate via busses such as based on the Advanced Microcontroller Bus Architecture protocol (e.g., AMBA available from ARM Holdings).

The integrated system—whether implemented as a SoC or not, may be included as part of a computing system with other elements including, but not limited to, a mass storage device, display, and network connectivity devices. It can be understood that the mass storage device may involve one or more memory components including integrated and removable memory components.

Certain methods and processes described herein can be embodied as code and/or data, which may be stored on one or more memory storage. Memory storage may comprise any computer readable storage media readable by a processor and capable of storing software. Memory storage may include volatile and nonvolatile, removable and non-removable media implemented in any method or technology for storage of information, such as computer readable instructions, data structures, program modules, or other data.

Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal. In addition to storage media, in some implementations, communication media over which software may be communicated internally or externally may be included in the system. Memory storage may be implemented as a single storage device but may also be implemented across multiple storage devices or sub-systems co-located or distributed relative to each other. Memory storage may comprise additional elements, such as a controller, capable of communicating with the one or more processors and devices of the integrated system or SoC of certain implementations.

Software may be implemented as program instructions and among other functions may, when executed by a computing system in general or one or more of the processors in particular, direct the computing system or the one or more of the processors to operate as described herein. Software may include additional processes, programs, or components. Software may also comprise firmware or some other form of machine-readable processing instructions executable by a processor.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A system comprising:
a first processor; and
at least one additional processor sharing a page table with the first processor and having a different instruction set than that of the first processor;
wherein the page table comprises:
a first permission indicator for the first processor; and
a second permission indicator for the at least one additional processor.

2. The system of claim 1, wherein the first permission indicator and the second permission indicator are provided as at least two bits of the page table.

3. The system of claim 2, wherein the second permission indicator comprises a separate indicator bit for each of the at least one additional processor.

4. The system of claim 1, wherein the first permission indicator and the second permission indicator are provided as at least one bit of the page table, wherein the second permission indicator comprises a shared indicator bit with the first permission indicator.

5. The system of claim 4, further comprising a processor identifier table stored at a memory location and encoding permissions of the shared indicator bit.

6. The system of claim 2, wherein the at least two bits of the page table encode the first permission indicator and the second permission indicator, wherein a first value of the at least two bits indicates the first permission indicator for the processor, a second value of the at least two bits indicates the second permission indicator for at least one of the at least one additional processor, and a third value of the at least two bits indicates a fault condition.

7. A method of accessing memory comprising:
accessing a page table shared by a first processor and at least one additional processor sharing a physical memory with the first processor and having a different instruction set than that of the first processor, wherein the page table comprises a first permission indicator for the first processor and a second permission indicator for the at least one additional processor; and
performing a designated action with respect to a page of the physical memory based on a value of the first permission indicator or the second permission indicator, the value being indicative of a permission related to the designated action.

8. The method of claim 7, wherein the first permission indicator is at least one bit of the page table and the second permission indicator is at least one additional bit of the page table.

9. The method of claim 7, wherein the first permission indicator and the second permission indicator is a shared at least two bits of the page table encoding the value indicative of the permission related to the designated action.

10. The method of claim 7, wherein the designated action is execute.

11. The method of claim 7, wherein the designated action is read or write.

12. The method of claim 7, wherein the designated action is kernel access.

13. A method of accessing memory comprising:
receiving a virtual memory address;
translating the virtual memory address to a physical memory address using a page table shared by a first processor and at least one additional processor having a different instruction set than that of the first processor; and
utilizing permission bits of the page table to control physical memory access, the permission bits comprising a first permission bit supporting the first processor and at least one permission bit to accommodate encodings that support the at least one additional processor.

14. The method of claim 13, wherein the first permission bit supporting the first processor and the at least one permission bit to accommodate encodings that support the at least one additional processor are at least two bits that separately indicate permissions for the first processor and the at least one additional processor.

15. The method of claim 13, wherein the first permission bit supporting the first processor and the at least one permission bit to accommodate encodings that support the at least one additional processor are a shared at least two bits of the page table encoding the value indicative of a permission for each processor.

16. The method of claim 15, wherein a first value of the shared at least two bits indicates permission for the first processor, and a second value of the shared at least two bits indicates permission for at least one of the at least one additional processor.

17. The method of claim 16, wherein the first permission bit and the at least one permission bit to accommodate encodings that support the at least one additional processor are a shared at least one bit of the page table encoding the value indicative of a permission for each processor, the method further comprising:
accessing a processor identifier table encoding permissions of the shared at least one bit when utilizing the permission bits of the page table to control the physical memory access.

18. The method of claim 15, wherein utilizing permission bits of the page table to control physical memory access comprises enabling execution of instructions stored in the physical memory.

19. The method of claim 15, wherein utilizing permission bits of the page table to control physical memory access comprises enabling reading data from or writing data to the physical memory.

20. The method of claim 15, wherein utilizing permission bits of the page table to control physical memory access comprises enabling kernel access.
